(19) United States
(12) Patent Application Publication
(10) Pub. No.: US 2026/0230998 A1
(43) Pub. Date: Aug. 6, 2026

(54) METHODS TO POSTPONE CELL RESELECTION DURING NTN DISCONTINUOUS COVERAGE

(71) Applicant: Telefonaktiebolaget LM Ericsson (publ), Stockholm (SE)

(72) Inventors: Ignacio Javier PASCUAL PELAYO, Stockholm (SE); Mattias BERGSTRÖM, Sollentuna (SE); Emre YAVUZ, Stockholm (SE); Johan RUNE, Lidingö (SE); Helka-Liina MÄÄTTÄNEN, Espoo (FI); Santhan THANGARASA, Vällingby (SE)

(21) Appl. No.: 19/157,250

(22) PCT Filed: Feb. 16, 2024
(86) PCT No.: PCT/EP2024/054012

§ 371 Date: Aug. 15, 2025

Related U.S. Application Data
(60) Provisional application No. 63/446,251, filed on Feb. 16, 2023.

(51) Int. Cl. H04W 48/02; H04W 48/20; H04W 84/06

(52) U.S. Cl. CPC H04W 48/02; H04W 48/20; H04W 84/06

(57) ABSTRACT

A method, system and apparatus are disclosed. A method in a user equipment (UE) configured to communicate with a first network node (NN) and a second NN is described. The first NN is associated with a first cell, and the second NN is associated with a second cell. The method includes determining a postponement of a cell selection action, where the cell selection action includes selecting the second cell for communication with the UE. The postponement is determined based on predetermined criteria associated with one or both of the UE and the second NN. The method further includes performing the postponement of the cell selection action based on the determination.

### TECHNICAL FIELD

The present disclosure relates to wireless communications, and in particular, to cell selection associated with non-terrestrial networks (NTNs).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and mobile user equipment (UE), as well as communication between network nodes and between UEs. The 3GPP is also developing standards for Sixth Generation (6G) wireless communication networks.

A 3GPP 5G system (5GS) is a generation of radio access technology (RAT) intended to serve use cases such as enhanced mobile broadband (eMBB), ultra-reliable and low latency communication (URLLC), NarrowBand Internet of Things (NB-IoT) and massive machine type communication (mMTC). 5G includes an NR access stratum interface and 5G Core Network (5GC). NR physical and higher layers may reuse parts of the LTE specification, and to that may add needed components when motivated by new use cases. To benefit from the strong mobile ecosystem and economy of scale, a satellite network based on the terrestrial wireless access technologies including LTE and NR for satellite networks, is being specified in 3GPP standards.

### IoT NTN and NTN Characteristics

A satellite radio access network may include the following components:
A satellite that refers to a space-borne platform.
An earth-based gateway that connects the satellite to a base station or a core network, depending on the choice of architecture.
Feeder link that refers to the link between a gateway and a satellite.
Access link, or service link, which refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A satellite which does not operate in geostationary earth orbit is also broadly called a NGSO (Non-Geostationary Orbit) satellite. Examples of NGSO satellites are LEO and MEO satellites.

Two basic architectures can be distinguished for satellite communication networks (depending on the functionality of the satellites in the system) may be:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that a NN (e.g., gNB) is located on the ground and another NN (e.g., the satellite) forwards signals/data between the NN and the UE.
Regenerative payload. The satellite includes on-board processing to demodulate and decode the received signal and regenerate the signal before sending it back to the earth. When applied to general 3GPP architecture and terminology, the regenerative payload architecture means that the NN (e.g., gNB) is located in the satellite.

In the work item for NR NTN in 3GPP release 17, only the transparent payload architecture is considered.

A satellite network or satellite based mobile network may also be referred to as a non-terrestrial network (NTN). Further, mobile network with NNs (e.g., base stations) on the group may also be referred to as a terrestrial network (TN) or non-NTN network. A NN (e.g., satellite) within NTN may be referred to as an NTN node, NTN satellite or a satellite.

FIG. 1 shows an example architecture of a satellite network with bent pipe transponders (i.e., the transparent payload architecture). More specifically, the NN (e.g., gNB) may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits is required to provide continuous coverage across the full globe. Launching a mega satellite constellation is both an expensive and time-consuming procedure. It is therefore expected that all LEO and EO satellite constellations for some time will only provide partial earth-coverage. In the case of some constellations dedicated to massive IoT services with relaxed latency requirements, it may not even be necessary to support full earth-coverage. It may be sufficient to provide occasional or periodic coverage according to the orbital period of the constellation.

A 3GPP device in certain radio resource control (RRC) communication modes such as RRC_IDLE or RRC_INACTIVE state may be required to perform number of procedures including measurements for mobility purposes, paging monitoring, logging measurement results, tracking area update, and search for a new network, e.g., public land mobile network (PLMN). These procedures consume power in devices, and a general trend in 3GPP has been to allow for relaxation of these procedures to prolong device battery life. This trend has been especially pronounced for IoT devices supported by reduced capability (redcap), NB IoT and LTE M.

Further, propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle F seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Table 1 assumes regenerative payload architecture. For the transparent payload case, the propagation delay between gateway and satellite needs to be considered as well, unless the base station corrects for that.

TABLE 1
Propagation delay for different orbital heights and elevation angles.

| | | Distance | One-way | Propagation |
|---|---|---|---|---|
| Orbital | Elevation | UE <-> | propagation | delay |
| height | angle | satellite | delay | difference |
| — 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

### Ephemeris Data

3GPP technical report (TR) 38.821 V16.20 describes that ephemeris data should be provided to the UE, for example to assist with pointing a directional antenna (or an antenna beam) towards the satellite. A UE knowing its own position, e.g. thanks to GNSS support, may also use the ephemeris data to calculate correct timing related and/or frequency drifts e.g. Timing Advance (TA) and Doppler shift. The contents of the ephemeris data and the procedures on how to provide and update such data have not yet been studied in detail.

A satellite orbit may be fully described using six parameters. Exactly which set of parameters is used can be decided by the user, where many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g. the time when the satellites move through periapsis). The set of these parameters is illustrated in FIG. 2.

A two-line element set (TLE) is a data format encoding a list of orbital elements of an Earth-orbiting object for a given point in time, the epoch. As an example of a different parametrization, TLEs use mean motion n and mean anomaly M instead of a and t.

Another set of parameters is the position and velocity vector (x, y, z, vx, vy, vz) of a satellite. These are sometimes called orbital state vectors and can be derived from the orbital elements (and vice versa) since the information they contain may be equivalent. All these formulations (and many others) are possible choices for the format of ephemeris data to be used in NTN.

Additionally, the ephemeris data may be accompanied with information on possible coverage area, or timing information when the satellite is going to serve a certain geographical area on Earth.

### Satellite Discontinuous Coverage

Discontinuous coverage refers to the situation where the visibility of a satellite or group of satellites, commonly Low Earth Orbit (LEO), from a certain ground point is limited in time leading to periods without any satellite network coverage. The rapid movement of NGSO (Non-Geostationary Orbit) satellites around Earth is the cause of this time limitation and its length depends on the characteristics of the satellite constellation (e.g., structure, total number of satellites, number of orbital planes, or satellites per plane) and UE (e.g., minimum elevation angle, or local radio conditions). Hence, the use of partial, sparse, or incomplete constellations where the number of satellites is not enough to provide continuous coverage in a region will result in satellite network coverage gaps. This may be a case in early IoT NTN deployments due to the relaxed delay requirements and traffic profiles typical of IoT applications.

In 3GPP Release 17 (Rel-17), a UE centric solution to evaluate coverage gaps was standardized for IoT NTN. The assistance information sent to the UE includes satellite mean ephemeris in Two-Line Element (TLE) format, satellite ID and coverage information. Additionally, in quasi-Earth fixed cell deployments, the network may provide the absolute start serving time (T-service-start) instead of the satellite's ephemeris. This information is used by the ULE to estimate when the same or next satellite will be visible from its current location so that it can enter into a deep sleep state in between the satellite passes when there is no available coverage.

3GPP technical specification (TS) 36.304 V18.0.0 describes that a UE is required perform cell (re-)selection to the best possible/configured alternative whenever signal strength in the serving cell falls below a certain threshold (e.g., there is a gap in coverage). A UE camping in an NTN cell may lose its NTN coverage temporarily due to the movement of satellites and discontinuous coverage scenario, e.g., non-terrestrial network not being able to offer continuous service over a certain area.

When NTN coverage is regained, a ULE in RRC_IDLE mode may perform cell reselection from the TN cell to the NTN cell following the established criteria for cell reselection. Idle mode mobility between NTN and TN requires the UE to perform Tracking Area Update procedure, given that different cell types are associated with different Tracking Areas. The duration of coverage gaps in an NTN may range from seconds to hours. That is, a UE may suffer from a “ping-pong” effect between TN and NTN which leads to increased battery consumption and network resources.

### SUMMARY

Some embodiments advantageously provide methods, systems, and apparatuses for postponement of cell selection during NTN discontinuous coverage.

A UE camping in an NTN cell may lose its NTN coverage temporarily due to the movement of satellites and discontinuous coverage scenario, e.g., non-terrestrial network not being able to offer continuous service over a certain area. In such a scenario, a “best available alternative” may be a terrestrial network (TN) cell with a serving cell signal strength more than a certain threshold and/or the serving cell signal strength less than what it would be in the NTN cell if coverage was available. Similarly, the alternative may be an “acceptable” cell (according to the RRC_IDLE service types) with limited service.

Further, a ULE camping on an NTN cell may experience discontinuous coverage due to the movement of NGSO satellites and a lack of sufficient satellites to provide service continuity. In this scenario, a UE may experience the temporary unavailability of NTN cells, i.e., a cell of a first type. When a ULE is out of coverage of its serving cell, the UE may perform cell (re-) selection to the best available alternative. Depending on the duration of the associated NTN coverage gap, the implicit actions related to cell (re-)selection and/or Tracking Area Update between NTN and TN cells might be resource and power demanding leading to a trade-off.

In some embodiments, a method for postponing cell (re-)selection is described. Postponement of cell (re-)selection may be performed whenever the best available alternative is a TN cell, i.e., cell of a second type, and/or some specific criterion related to mobility, cell service and reservations, duration of the coverage gap, traffic patterns or signal situation is fulfilled (e.g., from UE and network perspectives).

One or more embodiments are beneficial at least because the UE may avoid frequent cell reselection between NNs (e.g., between TN and NTN) when the duration of NTN coverage gaps is short and the impact of the delay for uplink (UL) and downlink (DL) transmissions is limited, e.g., UE is a delay tolerant IoT device. This would lead to reduced UE battery consumption and network resource use.

According to one aspect, A user equipment (UE) configured to communicate with a first network node (NN) and/or a second NN. The first NN is associated with a first cell, and the second NN is associated with a second cell. The UE is configured to, and/or comprises a radio interface and/or processing circuitry configured to determine a postponement of a cell selection action when the cell selection action is selecting the second cell for communication with the UE. The postponement is determined based on predetermined criteria associated with one or both of the UE and the second NN.

In some embodiments, the UE is configured to one or more of determine the first cell has become unavailable to communicate with the first NN; determine the cell selection action is to select the second cell associated with the second NN based on the determination that the first cell has become unavailable; postpone the cell selection action based on the determined postponement; and one or both of receive and transmit signaling based on the postponement.

In some other embodiments, the predetermined criteria comprise one or more of: a mobility parameter, a cell service parameter; a cell reservation parameter; duration of a coverage gap associated with the first cell; a traffic pattern; and a signal parameter.

In some embodiments, one or more of: the first NN is associated with a non-terrestrial network (NTN); the second NN is associated with a terrestrial network (TN); the first NN is a satellite; and the second NN is a TN NN.

According to another aspect, a method in a user equipment (UE) configured to communicate with a first network node (NN) and/or a second NN is described. The first NN is associated with a first cell, and the second NN is associated with a second cell. The method comprises determining a postponement of a cell selection action when the cell selection action is selecting the second cell for communication with the UE. The postponement is determined based on predetermined criteria associated with one or both of the UE and the second NN.

In some embodiments, the method further comprises one or more of: determining the first cell has become unavailable to communicate with the first NN; determining the cell selection action is to select the second cell associated with the second NN based on the determination that the first cell has become unavailable; postponing the cell selection action based on the determined postponement; and one or both of receiving and transmitting signaling based on the postponement.

In some other embodiments, the predetermined criteria comprise one or more of: a mobility parameter, a cell service parameter; a cell reservation parameter; duration of a coverage gap associated with the first cell; and a traffic pattern; and a signal parameter.

In some embodiments, one or more of: the first NN is associated with a non-terrestrial network (NTN); the second NN is associated with a terrestrial network (TN); the first NN is a satellite; and the second NN is a TN NN.

According to one aspect, a method in a user equipment (UE) configured to communicate with a first network node (NN) and a second NN is described. The first NN is associated with a first cell, and the second NN is associated with a second cell. The method includes determining a postponement of a cell selection action, where the cell selection action includes selecting the second cell for communication with the UE. The postponement is determined based on predetermined criteria associated with one or both of the UE and the second NN. The method also includes performing the postponement of the cell selection action based on the determination.

In some embodiments, the method further includes one or more of: (A) determining the first cell has become unavailable to communicate with the first NN; (B) determining that the cell selection action includes selecting the second cell associated with the second NN based on the determination that the first cell has become unavailable; and (C) one or both of receiving and transmitting signaling based on the postponement.

In some other embodiments, the predetermined criteria comprise one or more of a mobility parameter, a cell service parameter, a cell reservation parameter, duration of a coverage gap associated with the first cell, a traffic pattern, and a signal parameter.

In some embodiments, the method further includes determining a duration of one or more coverage gaps associated with one or both of the first cell and the first NN based on a system information block and when the one or more coverage gap start, stopping one or more functions related to one or both of the first cell and the first NN and reselecting one of the first cell and second cell based on the predetermined criteria.

In some other embodiments, the method further includes when the UE moves from the first cell to the second cell based on the cell selection action and the second cell is associated with another tracking area, performing a tracking area update process during which the UE indicates at least to the second NN the other tracking area the UE has camped in.

In some embodiments, the method further includes receiving an indication from one or both of the first network node and the second NN. The indication indicates the UE to perform the postponement or to not perform the postponement and is based on one or more of a UE capability, historical traffic patterns of the UE, an expected next communication event, and data flow.

In some other embodiments, the postponement is autonomously determined by the UE further based on a predetermined threshold for an expected duration of a coverage gap in the first cell.

In some embodiments, the postponement is autonomously determined by the UE further based on one or both of a battery status and an energy status associated with the UE.

In some other embodiments, the postponement is autonomously determined by the UE further based on whether there is one or both of uplink data and downlink data pending to be transmitted during an expected duration of a coverage gap in the first cell.

In some embodiments, the method further includes one or both aborting the postponement of a cell selection action based on one or more conditions and one or both of transmitting and receiving signaling via the second cell.

In some other embodiments, the one or more conditions include one or more of: (A) the first cell not becoming available to the UE after a predetermined time; (B) a cell service type of the second cell changes to normal service; (C) a location of the UE has changed; (D) quality of experience below a quality of experience threshold if postponement is performed; (E) the UE being initiated; (F) a type of signal associated with the UE, the type of signal being critical; (G) a type of communication channel associated with the UE, the type of communication channel being critical; (H) the UE being preconfigured with one or more predetermined resources; (I) the UE having to perform one or more measurements; (J) a signal strength below a signal strength threshold; and (K) a signal quality below a signal quality threshold.

In some embodiments, one or more of the first NN is associated with a non-terrestrial network (NTN), the second NN is associated with a terrestrial network (TN), the first NN is a satellite, and the second NN is a TN NN.

13. A user equipment (UE) configured to communicate with a first network node (NN) and a second NN is described. The first NN is associated with a first cell, and the second NN is associated with a second cell. The UE is configured to determine a postponement of a cell selection action, where the cell selection action includes selecting the second cell for communication with the UE. The postponement is determined based on predetermined criteria associated with one or both of the UE and the second NN. The UE is also configured to perform the postponement of the cell selection action based on the determination.

In some embodiments, the UE is further configured to one or more of: (A) determine the first cell has become unavailable to communicate with the first NN; (B) determine that the cell selection action includes selecting the second cell associated with the second NN based on the determination that the first cell has become unavailable; and (C) one or both of receive and transmit signaling based on the postponement.

In some other embodiments, the predetermined criteria comprise one or more of a mobility parameter, a cell service parameter, a cell reservation parameter, duration of a coverage gap associated with the first cell, a traffic pattern, and a signal parameter.

In some embodiments, the UE is further configured to determine a duration of one or more coverage gaps associated with one or both of the first cell and the first NN based on a system information block and when the one or more coverage gap start, stop one or more functions related to one or both of the first cell and the first NN and reselect one of the first cell and second cell based on the predetermined criteria.

In some other embodiments, the UE is further configured to when the UE moves from the first cell to the second cell based on the cell selection action and the second cell is associated with another tracking area, perform a tracking area update process during which the UE indicates at least to the second NN the other tracking area the UE has camped in.

In some embodiments, the UE is further configured to receive an indication from one or both of the first NN and the second NN. The indication indicates the UE to perform the postponement or to not perform the postponement and is based on one or more of a UE capability, historical traffic patterns of the UE, an expected next communication event, and data flow.

In some other embodiments, the postponement is autonomously determined by the UE further based on a predetermined threshold for an expected duration of a coverage gap in the first cell.

In some embodiments, the postponement is autonomously determined by the UE further based on one or both of a battery status and an energy status associated with the UE.

In some other embodiments, the postponement is autonomously determined by the UE further based on whether there is one or both of uplink data and downlink data pending to be transmitted during an expected duration of a coverage gap in the first cell.

In some embodiments, the UE is further configured to one or both abort the postponement of a cell selection action based on one or more conditions and one or both of transmit and receive signaling via the second cell.

In some other embodiments, the one or more conditions include one or more of: (A) the first cell not becoming available to the UE after a predetermined time; (B) a cell service type of the second cell changes to normal service; (C) a location of the UE has changed; (D) quality of experience below a quality of experience threshold if postponement is performed; (E) the UE being initiated; (F) a type of signal associated with the UE, the type of signal being critical; (G) a type of communication channel associated with the UE, the type of communication channel being critical; (H) the UE being preconfigured with one or more predetermined resources; (I) the UE having to perform one or more measurements; (J) a signal strength below a signal strength threshold; and (K) a signal quality below a signal quality threshold.

In some embodiments, one or more of the first NN is associated with a non-terrestrial network (NTN), the second NN is associated with a terrestrial network (TN), the first NN is a satellite, and the second NN is a TN NN.

According to one aspect, a method in a second network node (NN) configured to communicate with a user equipment (UE) is described. The UE is configured to communicate with a first network node (NN) associated with a first cell. The second NN is associated with a second cell. The method includes determining a first indication indicating a postponement of a cell selection action. The cell selection action includes selecting the second cell for communication with the UE. The postponement is based on predetermined criteria associated with one or both of the UE and the second NN. The method also includes transmitting the first indication to the UE based on the determination.

In some embodiments, the predetermined criteria comprise one or more of a mobility parameter, a cell service parameter, a cell reservation parameter, duration of a coverage gap associated with the first cell, a traffic pattern, and a signal parameter.

In some other embodiments, the method further includes receiving a second indication from the UE, where the second indication indicates another tracking area the UE has camped in when the UE moves from the first cell to the second cell based on the cell selection action.

In some embodiments, the first indication indicates the UE to perform the postponement or to not perform the postponement.

In some other embodiments, the first indication is further determined being based on one or more of a UE capability, historical traffic patterns of the UE, an expected next communication event, and data flow.

In some embodiments, the first indication causes the UE to one or more abort the postponement of a cell selection action based on one or more conditions and one or both of transmit and receive signaling via the second cell.

In some other embodiments, the one or more conditions include one or more of: (A) the first cell not becoming available to the UE after a predetermined time; (B) a cell service type of the second cell changes to normal service; (C) a location of the UE has changed; (D) quality of experience below a quality of experience threshold if postponement is performed; (E) the UE being initiated; (F) a type of signal associated with the UE, the type of signal being critical; (G) a type of communication channel associated with the UE, the type of communication channel being critical; (H) the UE being preconfigured with one or more predetermined resources; (I) the UE having to perform one or more measurements; (J) a signal strength below a signal strength threshold; and (K) a signal quality below a signal quality threshold.

In some embodiments, one or more of the first NN is associated with a non-terrestrial network (NTN), the second NN is associated with a terrestrial network (TN), the first NN is a satellite, and the second NN is a TN NN.

According to another aspect, a second network node (NN) configured to communicate with a user equipment (UE) is described. The UE is configured to communicate with a first network node (NN) associated with a first cell, and the second NN is associated with a second cell. The second NN is configured to determine a first indication indicating a postponement of a cell selection action, the cell selection action including selecting the second cell for communication with the UE, the postponement being based on predetermined criteria associated with one or both of the UE and the second NN. The second NN is further configured to transmit the first indication to the UE based on the determination.

In some embodiments, the predetermined criteria comprise one or more of a mobility parameter, a cell service parameter, a cell reservation parameter, duration of a coverage gap associated with the first cell, a traffic pattern, and a signal parameter.

In some other embodiments, the second NN is further configured to receive a second indication from the UE. The second indication indicates another tracking area the UE has camped in when the UE moves from the first cell to the second cell based on the cell selection.

In some embodiments, the first indication indicates the UE to perform the postponement or to not perform the postponement.

In some other embodiments, the first indication is further determined being based on one or more of a UE capability, historical traffic patterns of the UE, an expected next communication event, and data flow.

In some embodiments, the first indication causes the UE to one or more abort the postponement of a cell selection action based on one or more conditions and one or both of transmit and receive signaling via the second cell.

In some other embodiments, the one or more conditions include one or more of: (A) the first cell not becoming available to the UE after a predetermined time; (B) a cell service type of the second cell changes to normal service; (C) a location of the UE has changed; (D) quality of experience below a quality of experience threshold if postponement is performed; (E) the UE being initiated; (F) a type of signal associated with the UE, the type of signal being critical; (G) a type of communication channel associated with the UE, the type of communication channel being critical; (H) the UE being preconfigured with one or more predetermined resources; (I) the UE having to perform one or more measurements; (J) a signal strength below a signal strength threshold; and (K) a signal quality below a signal quality threshold.

In some embodiments, one or more of the first NN is associated with a non-terrestrial network (NTN), the second NN is associated with a terrestrial network (TN), the first NN is a satellite, and the second NN is a TN NN.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example architecture of a satellite network with bent pipe transponders;

FIG. 2 shows example orbital elements;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a UE over an at least partially wireless connection according to some embodiments of the present disclosure;

FIG. 5 is a flowchart illustrating exemplary methods implemented in a communication system including a host computer, a network node and a UE for executing a client application at a UE according to some embodiments of the present disclosure;

FIG. 6 is a flowchart illustrating exemplary methods implemented in a communication system including a host computer, a network node and a UE for receiving user data at a UE according to some embodiments of the present disclosure;

FIG. 7 is a flowchart illustrating exemplary methods implemented in a communication system including a host computer, a network node and a UE for receiving user data from the UE at a host computer according to some embodiments of the present disclosure;

FIG. 8 is a flowchart illustrating exemplary methods implemented in a communication system including a host computer, a network node and a UE for receiving user data at a host computer according to some embodiments of the present disclosure;

FIG. 9 is a flowchart of an exemplary process in a UE according to some embodiments of the present disclosure;

FIG. 10 is a flowchart of an exemplary process in a UE according to some embodiments of the present disclosure; and

FIG. 11 is a flowchart of an exemplary process in a NN according to some embodiments of the present disclosure.

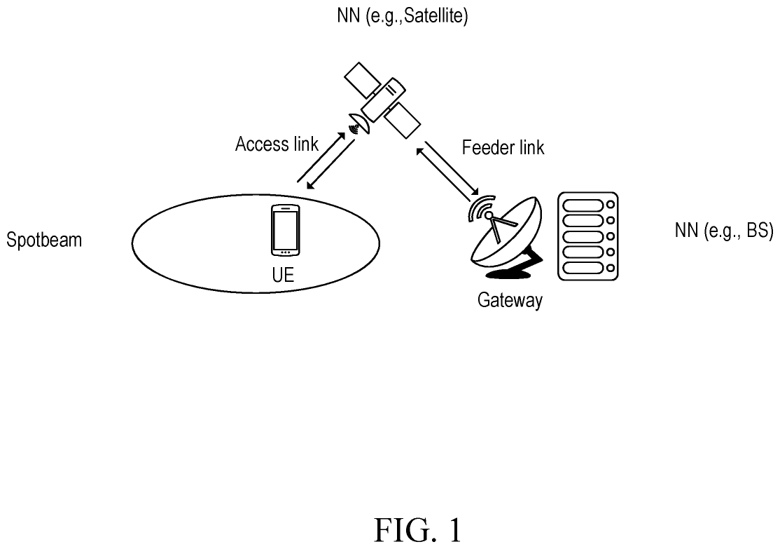

### DETAILED DESCRIPTION

Before describing in detail exemplary embodiments, it is noted that the embodiments reside primarily in combinations of apparatus components and processing steps related to postponement of cell selection during NTN discontinuous coverage. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a UE such as a wireless device (WD) or a radio network node.

In some embodiments, the non-limiting terms user equipment (UE) and wireless device (WD) are used interchangeably. The UE herein can be any type of UE capable of communicating with a network node or another UE over radio signals, such as user equipment (UE). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), JAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

One or more embodiments are described in terms of LTE based (e.g., including IoT) NTNs. However, one or more embodiments are equally applicable in an NTN based on NR (e.g., including IoT) technology or any other radio access technology (RAT).

In some embodiments the term “network” is used and may refer to a network node, which may be an eNB (e.g., in a LTE based NTN), but which may also be a gNB (e.g. in a NR based NTN), or a base station or an access point in another type of network, or any other network node with the ability to directly or indirectly communicate with a UE.

In some other embodiments, Global Navigation Satellite Systems (GNSS) is used which may include Global Positioning System (GPS) and/or other GNSS also configured to provide one or more functionalities described herein, e.g. Global Navigation Satellite System (GLONASS), BeiDou Navigation Satellite System, and the European Galileo system.

In some embodiments, the terms “connected mode”, “RRC_CONNECTED state” or “RRC_CONNECTED mode” may be used interchangeably.

In some other embodiments, the terms “satellite footprint information” and “satellite assistance information” (SAI) refer to the minimum necessary information that allows a UE to determine the size and location on Earth of an NTN cell. In the case of earth fixed cells, this information may include but is not limited to cell radius and cell reference location. In case of earth-moving cells, this information includes but is not limited to satellite ephemeris, minimum elevation angles, cell radius and/or cell reference location offset with respect to the satellite's nadir, for beams that are not evenly distributed around nadir and might have a certain inclination.

In some embodiments, the value of t-service-r17 may be referred to as “remaining service time” or “current cell stop serving time”. This parameter informs the UE when the satellite (e.g., normally operating in a LEO or EO) that is serving the cell to which the UE is connected will stop serving the area due to its movement.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

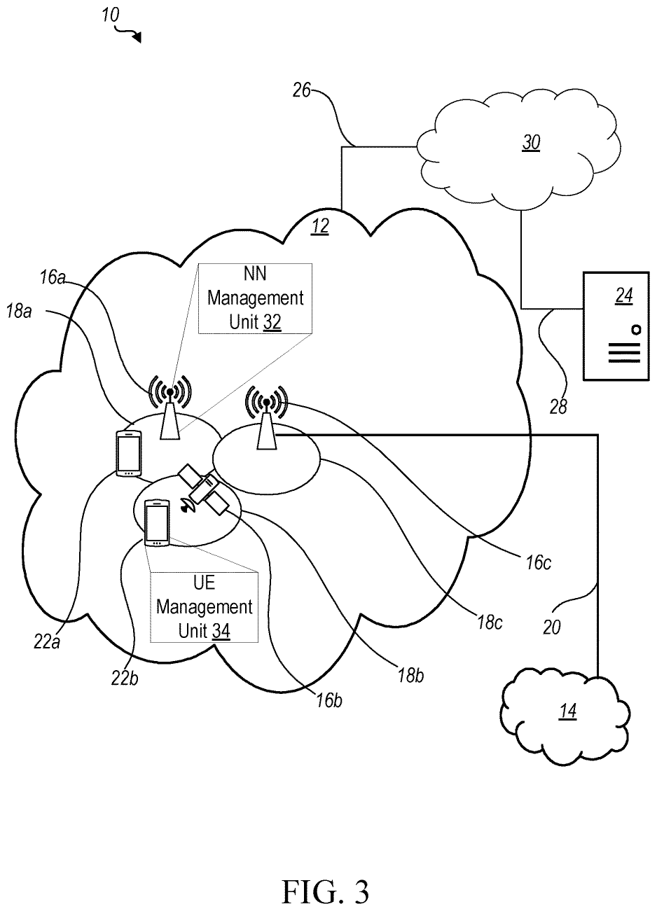

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an network 12 (e.g., TN, access network such as a radio access network, etc.), and a network 14 (e.g., NTN, core network, etc.). The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Although network node 16b is shown as a satellite, any one of network nodes 16 may be an NTN network node such as a satellite or a terrestrial network node such as a base station, gNB, etc. Each network node 16a, 16b, 16c is connectable to and/or be part of the core network 14 over a wired or wireless connection 20. For example, a NN 16 (e.g., terrestrial network node, NTN network node, satellite, etc.) may be part of network 14 (e.g., NTN). In addition, any other component of system 10 may be part of a TN or NTN, such as access network 12. A first UE 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as UEs 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 can be in simultaneous communication and/or configured to separately communicate with more than one network node 16 and more than one type of network node 16. For example, a UE 22 can have dual connectivity with a network node 16 that supports LTE and the same or a different network node 16 that supports NR. As an example, UE 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a NN management unit 32 which is configured to perform any step and/or task and/or process and/or method and/or feature described in the present disclosure, e.g., cause transmission of signal based on a postponement of cell selection. A UE 22 is configured to include a UE management unit 34 configured to perform any step and/or task and/or process and/or method and/or feature described in the present disclosure, e.g., determine a postponement of cell section.

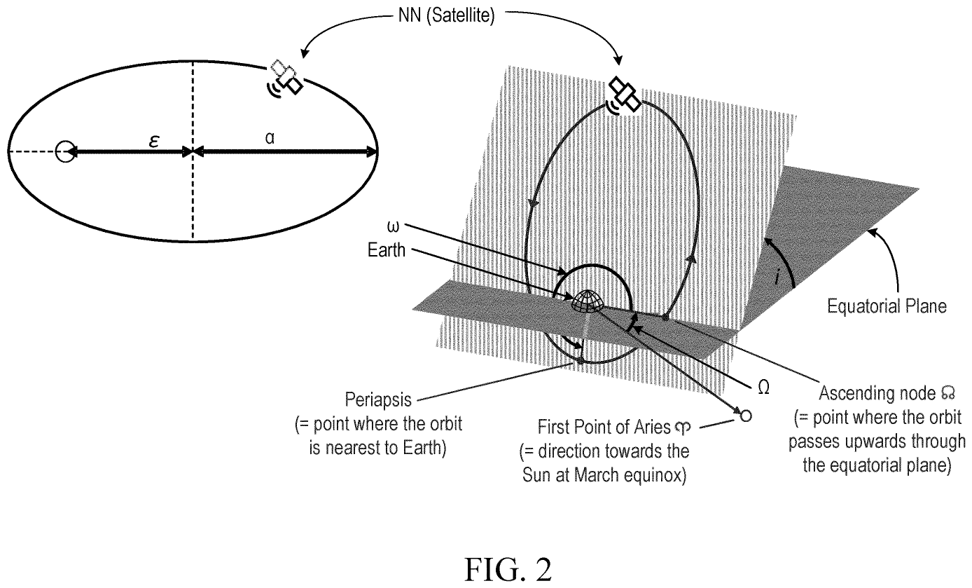

Example implementations, in accordance with an embodiment, of the UE 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a ULE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the UE 22. The processing circuitry 42 of the host computer 24 may include a host unit 54 configured to enable the service provider to observe/monitor/control/transmit to/receive from the network node 16 and or the UE 22.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN management unit 32 which is configured to perform any step and/or task and/or process and/or method and/or feature described in the present disclosure, e.g., cause transmission of signal based on a postponement of cell selection.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the ULE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by ULE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the ULE 22 may include a UE management unit 34 configured to perform any step and/or task and/or process and/or method and/or feature described in the present disclosure, e.g., determine a postponement of cell section.

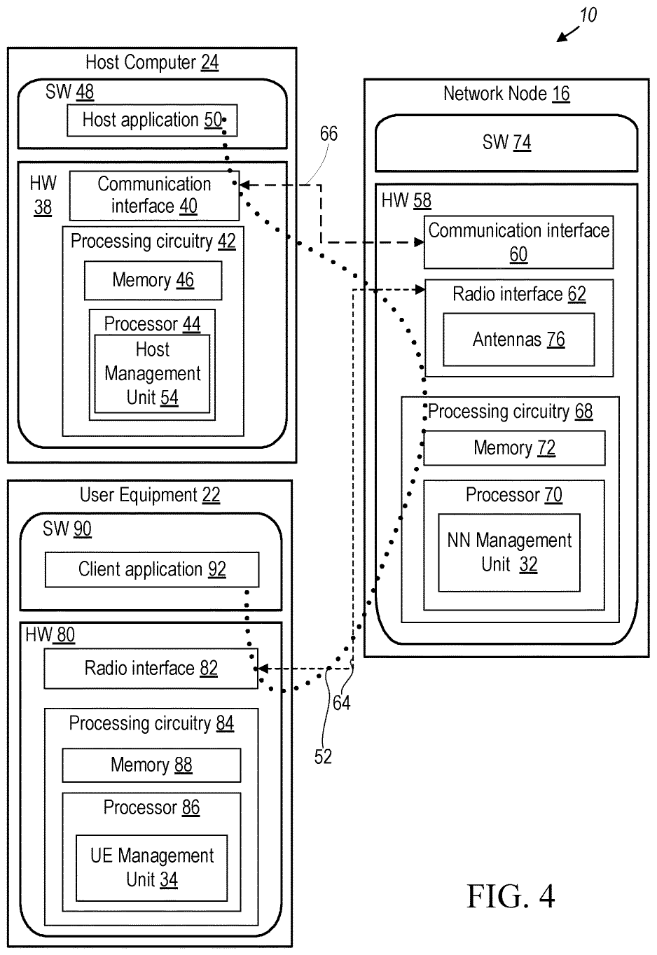

In some embodiments, the inner workings of the network node 16, UE 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the UE 22 via the network node 16, without explicit reference to any intermediary devices and the precise routing of messages via these devices. Network infrastructure may determine the routing, which may be configured to be hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22 and the network node 16 is in accordance with the teachings of the embodiments described throughout this disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as NN management unit 32, and UE management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

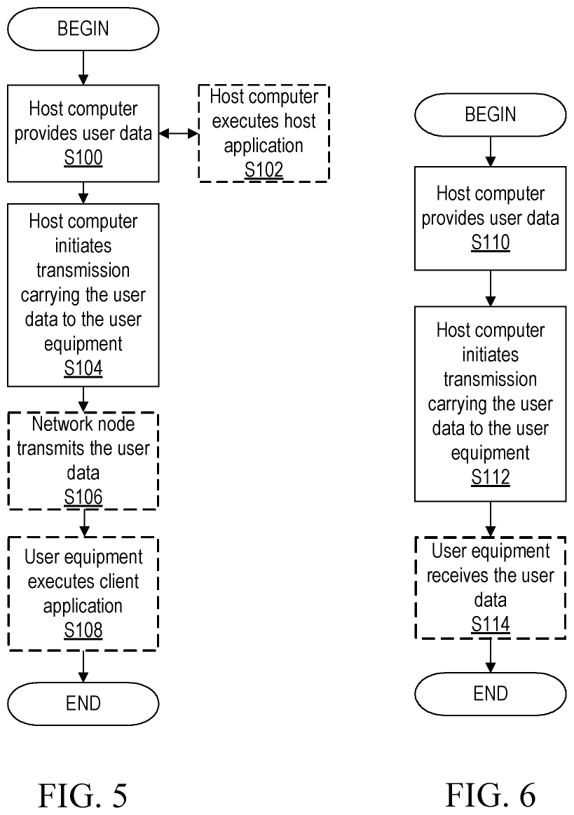

FIG. 5 is a flowchart illustrating an exemplary method implemented in a communication system, such as, for example, the communication system of FIGS. 3 and 4, in accordance with one embodiment. The communication system may include a host computer 24, a network node 16 and a UE 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 6 is a flowchart illustrating an exemplary method implemented in a communication system, such as, for example, the communication system of FIG. 3, in accordance with one embodiment. The communication system may include a host computer 24, a network node 16 and a UE 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

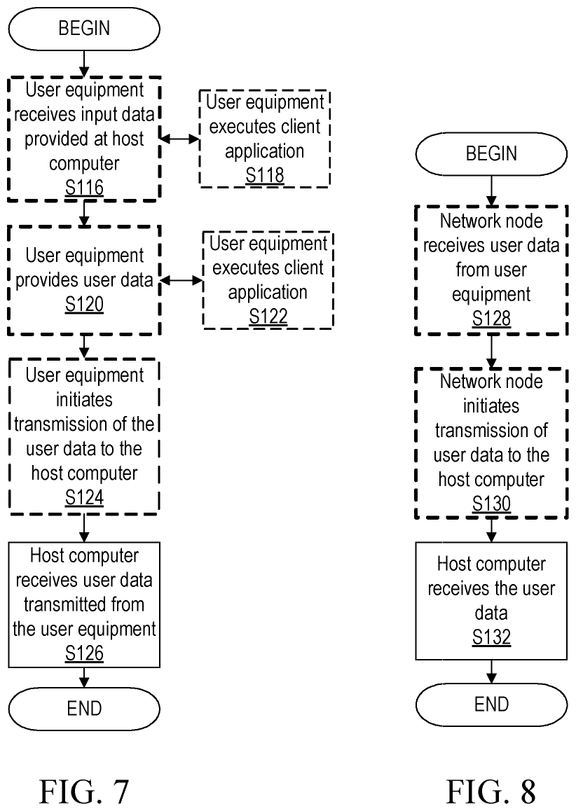

FIG. 7 is a flowchart illustrating an exemplary method implemented in a communication system, such as, for example, the communication system of FIG. 3, in accordance with one embodiment. The communication system may include a host computer 24, a network node 16 and a UE 22, which may be those described with reference to FIGS. 3 and 4. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 24, a network node 16 and a UE 22, which may be those described with reference to FIGS. 3 and 4. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

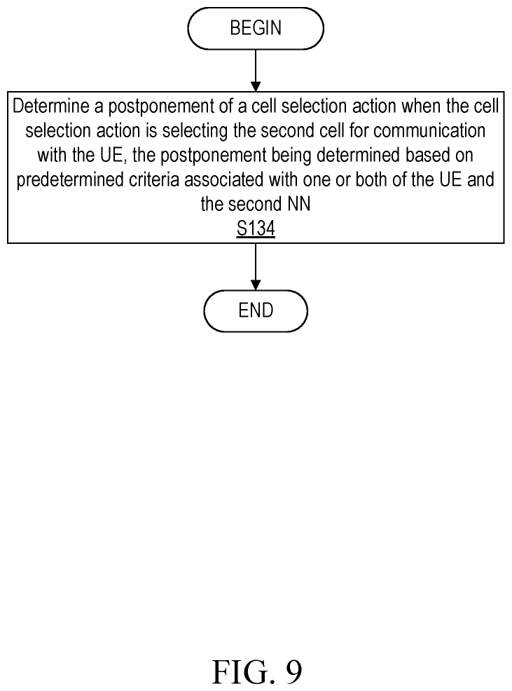

FIG. 9 is a flowchart of an exemplary process in a UE 22 (e.g., configured to communicate with a first NN 16 and/or a second NN 16) according to some embodiments of the present disclosure. One or more blocks described herein may be performed by one or more elements of UE 22 such as by one or more of processing circuitry 84 (including the UE management unit 34), processor 86, and/or radio interface 82. UE 22 such as via processing circuitry 84 and/or processor 86 and/or radio interface 82 is configured to determine (Block S134) a postponement of a cell selection action when the cell selection action is selecting the second cell for communication with the UE 22. The postponement being determined based on predetermined criteria associated with one or both of the UE 22 and the second NN 16.

In some embodiments, the method further comprises one or more of: determining the first cell has become unavailable to communicate with the first NN 16; determining the cell selection action is to select the second cell associated with the second NN 16 based on the determination that the first cell has become unavailable; postponing the cell selection action based on the determined postponement; and one or both of receiving and transmitting signaling based on the postponement.

In some other embodiments, the predetermined criteria comprise one or more of: a mobility parameter, a cell service parameter; a cell reservation parameter; duration of a coverage gap associated with the first cell; and a traffic pattern; and a signal parameter.

In some embodiments, one or more of: the first NN 16 is associated with a non-terrestrial network (NTN); the second NN 16 is associated with a terrestrial network (TN); the first NN 16 is a satellite; and the second NN 16 is a TN NN.

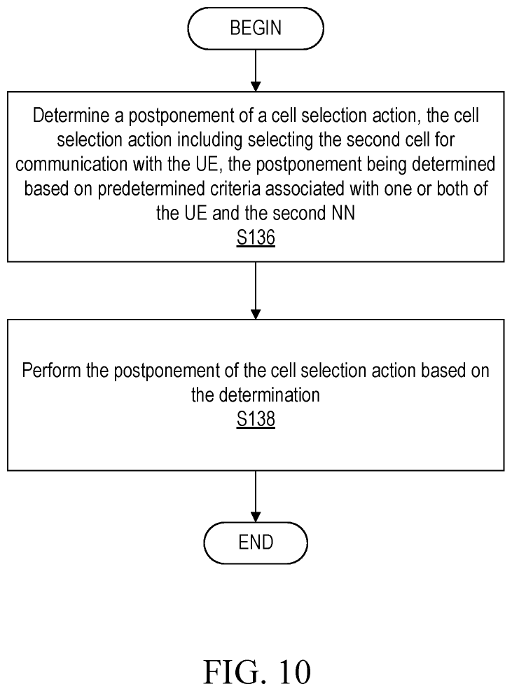

FIG. 10 is a flowchart of an exemplary process in a UE 22 (e.g., configured to communicate with a first NN 16 and/or a second NN 16) according to some embodiments of the present disclosure. One or more blocks described herein may be performed by one or more elements of UE 22 such as by one or more of processing circuitry 84 (including the UE management unit 34), processor 86, and/or radio interface 82. UE 22 such as via processing circuitry 84 and/or processor 86 and/or radio interface 82 is configured to determine (Block S136) a postponement of a cell selection action, where the cell selection action includes selecting the second cell for communication with the UE 22. The postponement is determined based on predetermined criteria associated with one or both of the UE 22 and the second NN 16. The UE 22 is also configured to perform (Block S138) the postponement of the cell selection action based on the determination.

In some embodiments, the method further includes one or more of: (A) determining the first cell has become unavailable to communicate with the first NN 16; (B) determining that the cell selection action includes selecting the second cell associated with the second NN 16 based on the determination that the first cell has become unavailable; and (C) one or both of receiving and transmitting signaling based on the postponement.

In some other embodiments, the predetermined criteria comprise one or more of a mobility parameter, a cell service parameter, a cell reservation parameter, duration of a coverage gap associated with the first cell, a traffic pattern, and a signal parameter.

In some embodiments, the method further includes determining a duration of one or more coverage gaps associated with one or both of the first cell and the first NN 16 based on a system information block and when the one or more coverage gap start, stopping one or more functions related to one or both of the first cell and the first NN 16 and reselecting one of the first cell and second cell based on the predetermined criteria.

In some other embodiments, the method further includes when the UE 22 moves from the first cell to the second cell based on the cell selection action and the second cell is associated with another tracking area, performing a tracking area update process during which the UE 22 indicates at least to the second NN 16 the other tracking area the UE 22 has camped in.

In some embodiments, the method further includes receiving an indication from one or both of the first NN 16 and the second NN 16. The indication indicates the UE 22 to perform the postponement or to not perform the postponement and is based on one or more of a UE capability, historical traffic patterns of the UE 22, an expected next communication event, and data flow.

In some other embodiments, the postponement is autonomously determined by the UE 22 further based on a predetermined threshold for an expected duration of a coverage gap in the first cell.

In some embodiments, the postponement is autonomously determined by the UE 22 further based on one or both of a battery status and an energy status associated with the UE 22.

In some other embodiments, the postponement is autonomously determined by the UE 22 further based on whether there is one or both of uplink data and downlink data pending to be transmitted during an expected duration of a coverage gap in the first cell.

In some embodiments, the method further includes one or both aborting the postponement of a cell selection action based on one or more conditions and one or both of transmitting and receiving signaling via the second cell.

In some other embodiments, the one or more conditions include one or more of: (A) the first cell not becoming available to the UE 22 after a predetermined time; (B) a cell service type of the second cell changes to normal service; (C) a location of the UE 22 has changed; (D) quality of experience below a quality of experience threshold if postponement is performed; (E) the UE 22 being initiated; (F) a type of signal associated with the UE 22, the type of signal being critical; (G) a type of communication channel associated with the UE 22, the type of communication channel being critical; (H) the UE 22 being preconfigured with one or more predetermined resources; (I) the UE 22 having to perform one or more measurements; (J) a signal strength below a signal strength threshold; and (K) a signal quality below a signal quality threshold.

In some embodiments, one or more of the first NN 16 is associated with a non-terrestrial network (NTN), the second NN 16 is associated with a terrestrial network (TN), the first NN 16 is a satellite, and the second NN 16 is a TN NN.

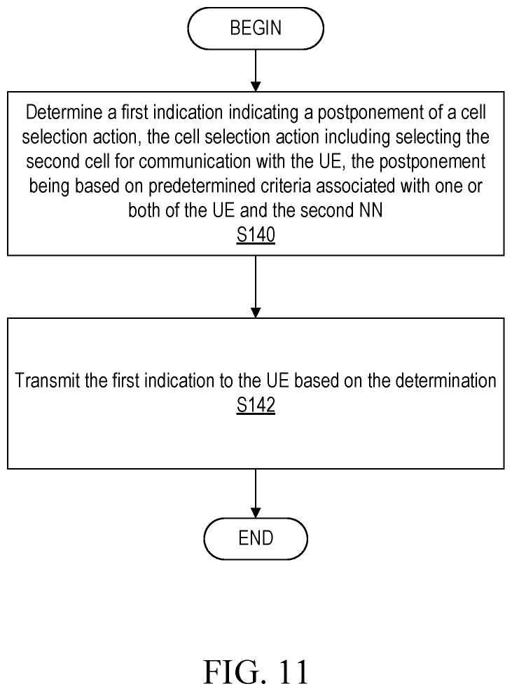

FIG. 11 is a flowchart of an exemplary process in a NN 16 (e.g., configured to communicate with a UE 22) according to some embodiments of the present disclosure. One or more blocks described herein may be performed by one or more elements of NN 16 such as by one or more of processing circuitry 67 (including the NN management unit 32), processor 70, radio interface 62 and/or communication interface 60. UE 22 such as via processing circuitry 84 and/or processor 86 and/or radio interface 82 is configured to determine (Block S140) a first indication indicating a postponement of a cell selection action. The cell selection action includes selecting the second cell for communication with the UE 22. The postponement is based on predetermined criteria associated with one or both of the UE 22 and the second NN 16. The NN 16 is also configured to transmit (Block S142) the first indication to the UE 22 based on the determination.

In some embodiments, the predetermined criteria comprise one or more of a mobility parameter, a cell service parameter, a cell reservation parameter, duration of a coverage gap associated with the first cell, a traffic pattern, and a signal parameter.

In some other embodiments, the method further includes receiving a second indication from the UE 22, where the second indication indicates another tracking area the UE 22 has camped in when the UE 22 moves from the first cell to the second cell based on the cell selection action.

In some embodiments, the first indication indicates the UE 22 to perform the postponement or to not perform the postponement.

In some other embodiments, the first indication is further determined being based on one or more of a UE capability, historical traffic patterns of the UE 22, an expected next communication event, and data flow.

In some embodiments, the first indication causes the UE 22 to one or more abort the postponement of a cell selection action based on one or more conditions and one or both of transmit and receive signaling via the second cell.

In some other embodiments, the one or more conditions include one or more of: (A) the first cell not becoming available to the UE 22 after a predetermined time; (B) a cell service type of the second cell changes to normal service; (C) a location of the UE 22 has changed; (D) quality of experience below a quality of experience threshold if postponement is performed; (E) the UE 22 being initiated; (F) a type of signal associated with the UE 22, the type of signal being critical; (G) a type of communication channel associated with the UE 22, the type of communication channel being critical; (H) the UE 22 being preconfigured with one or more predetermined resources; (I) the UE having to perform one or more measurements; (J) a signal strength below a signal strength threshold; and (K) a signal quality below a signal quality threshold.

In some embodiments, one or more of the first NN 16 is associated with a non-terrestrial network (NTN), the second NN 16 is associated with a terrestrial network (TN), the first NN 16 is a satellite, and the second NN 16 is a TN NN.

Having described the general process flow of arrangements of the disclosure and having provided examples of hardware and software arrangements for implementing the processes and functions of the disclosure, the sections below provide details and examples of arrangements for postponement of cell selection during NTN discontinuous coverage.

In some embodiments, a scenario where a UE 22 is camping in a cell (e.g., RRC_IDLE camping) is described. The scenario may refer to a quasi-earth fixed NTN cell but is not limited as such and may be applicable to any other type of NTN cell deployment (e.g., where the network provides the means for the UE 22 to calculate or estimate NTN coverage).

In some embodiments, the term mobility parameter is used and may refer to a parameter associated with the mobility of the UE 22, NTN network node 16, NTN cell, etc., and may include location of the UE 22, location of the NTN network node 16, mobility of a cell of the NTN network node 16. In some embodiments, the term cell service parameter is used and may refer to a service or service type associated with a cell provided by a network node 16. In some embodiments, the term cell reservation parameter is used and may refer to a parameter associated with the reservation of a cell to provide a specific service. In some embodiments, the term traffic pattern is used and may refer to a pattern of signaling between UE 22 and a network node 16 and/or corresponding cell. A signal parameter may refer to any parameter associated with signaling between UE 22 and a network node 16 and/or corresponding cell, e.g., a power parameter, quality parameter, etc.

In some other embodiments, network node 16 (e.g., at least via radio interface 62) may determine whether UE 22 does or does not postpone a cell reselection procedure (e.g., based on signaling from the UE 22 or lack of signaling, or other parameters such as signal power, signal quality, acknowledgment, etc.). In some embodiments, the TN and NTN cells (served by the TN network node 16 and the NTN network node 16, respectively) are configured to be in different tracking areas. When the coverage for the NTN cell is not available, UE 22 may perform reselection to the TN cell and since the TN cell is in another tracking area that would trigger connection establishment to perform the tracking area update (TAU). In some other embodiments, if UE 22 postpones the cell reselection procedure until NTN coverage returns, no connection establishment is triggered (e.g., at least for a period of time), but UE 22 may establish connection based on other parameters.

### Nonlimiting Example Scenario

A UE 22 in a communication mode (e.g., in RRC_IDLE) and camping in cell (e.g., an IoT NTN cell) is aware when the serving satellite stops covering its current location based on one or more parameters (e.g., from the parameter t-service-r17 (for quasi earth-fixed cells)), which may be broadcast in a system information block (e.g., SIB3) or any other resource. A similar mechanism may be used for Earth-moving cells and/or be based on the cell reference location and a distance threshold. In addition, a UE 22 may be also aware when there is a discontinuous coverage scenario and can autonomously calculate the duration of NTN coverage gaps from the content broadcast in another SIB such as SIB32 (e.g., t-service-start-r17). When an NTN coverage gap starts, a ULE 22 may stop one or more functions (e.g., application specific (AS) functions) related to NTN and reselect to the best alternative candidate according to a cell reselection criteria.

### Nonlimiting Embodiments

A UE 22 previously served by a first type of cell(s) (e.g., NTN cell) may be configured to determine and/or decide to postpone/skip performing the cell (re-) selection procedure to a second type of cell(s) (e.g., TN cell) in case cells of the first type are expected to be unavailable during a period of time T. The UE 22 may wait until the coverage from the first type of cell(s) is regained to perform cell (re-)selection even though it would be possible to immediately (re-)select a second type of cell(s), i.e., it is able to fulfill the camping criteria. In a related embodiment, this state can be defined as an intermediate cell reselection state where a UE 22 obtains downlink (DL) synchronization, read system information (SI), and/or is able to read warnings. In this mode, broadcast emergency warnings can be received, and UE 22 may perform emergency calls. In some embodiments, the network (e.g., NN) is not able to page the UE 22 as UE 22 has not performed a TAU procedure.

In some embodiments, when a UE 22 moves from a first cell to a second cell (performing cell (re-)selection procedure) and the second cell is associated with another tracking area, the UE 22 may perform a TAU procedure during which the UE 22 indicates to the (core) network the tracking area the UE 22 has camped in. According to this embodiment, the UE 22 either postpones or skips performing the TAU procedure and instead waits for coverage of the first type of cell(s) to return to, or re-appear at, the UE location. In some embodiments, the UE 22 postponing and/or skipping cell reselection may result in the UE 22 staying associated with, from RAN and core network perspectives, (i.e., camping on) the first type of cell. In some other embodiments, the UE 22 may not select the second type of cell which may belong to another tracking area and thereby also postpone/skip performing the TAU procedure.

In some embodiments, the UE 22 may postpone/skip the actions described above only in case the first and the second types of cells belong to different tracking areas.

Whether the UE 22 should postpone/skip the actions or not may be configured by the network (e.g., NN). For example, the network may indicate (e.g., in system information or in an RRC release message (e.g. an RRCConnectionRelease message) which moves the UE 22 from RRC CONNECTED to RRC IDLE/RRC INACTIVE (e.g., whether the UE 22 is expected to apply the postponement/skip behavior or not). In the case where the network (e.g. an eNB) instructs the UE 22 to postpone or not postpone its cell reselection to the second type of cell(s), e.g. in an RRC message, such as an RRC release message (e.g. an RRCConnectionRelease message) moving the UE 22 to RRC_IDLE or RRC_INACTIVE state or an RRCConnectionReconfiguration message, the network (e.g. the eNB) may base this instruction on one or more parameters (e.g. capabilities associated with the UE 22, historical traffic patterns of the UE 22 such as frequent or infrequent communication events, expected next communication event, any ongoing data flows, etc.).

In some other embodiments, the UE 22 autonomously decides whether to postpone/skip the cell reselection to the second type of cell(s) and wait for coverage of the first type of cell(s) to return, and the UE 22 may base this decision on a threshold for the expected duration of the coverage gap of the first type of cell(s), where the threshold e.g., may be set by UE 22 implementation.

In some embodiments, a UE 22 that autonomously decides whether to postpone/skip the cell reselection to the second type of cell(s) and wait for coverage of the first type of cell(s) to return may take its battery status or energy status (e.g., status of energy harvesting performance) into account in this decision. For example, the UE 22 may choose not to perform cell reselection to the second type of cell(s) and the subsequent consequent tracking area update if the UE 22 determines that this would consume energy beyond a predetermined threshold (or more energy than can be motivated by the possible performance gain of a cell reselection to a cell of the second type). Such a decision may also be altered, or moderated or impacted, if the UE 22 determines that there is (e.g., newly appeared) UL data pending to be transmitted, or UL/DL data expected to be transmitted from or to the UE 22 (e.g., predicted based on a communication schedule or regular communication pattern) during the expected duration of the gap in coverage of the first type of cell(s).

In some other embodiments, the UE 22 upon losing coverage of a serving cell of the first type (cell1) due to discontinuous coverage and detection (either prior or posterior to the coverage gap) of a cell of the second type (cell2), evaluates the cell of the second type (cell2) during an evaluation period (T1) before continuing with the cell (re-)selection procedure. That is, the UE 22 may enter in the previously mentioned intermediate cell reselection state and postpone the remaining of the cell (re-)selection procedure until the evaluation period is over, even if cell2 meets the exiting cell change criterion. The length of the evaluation period may be configured by network (e.g., NN) via System Information or a dedicated RRC message or determined autonomously by UE 22, e.g., by implementation.

### Aborting Postponement/Skipping

The UE 22 may be configured to abort the postponement process and/or perform actions related to cell (re-)selection. Example reasons to abort the postponement are captured in one or more of sections below.

Longer than Expected Unavailability

In one embodiment, the UE 22 postpones its cell (re-)selection to the second type of cells (and thus also postpones the tracking area update) until the coverage of the first type of cell(s) should return, as implied by the discontinuous coverage information in SIB32. However, if time passes the time when the coverage of the first type of cell(s) should return with some margin (e.g. a configured, specified, or UE 22 implementation specific threshold margin), and the coverage of the first type of cell(s) has not returned, then the UE 22 initiates the cell reselection to the second type of cell(s) and starts camping on a cell of the second type and performs the tracking area update.

More specifically, in case no cell(s) of the first type becomes available after the time T (alternatively after the time T plus a constant), the UE 22 may abort the postponement and continue with the cell reselection procedure to a cell of second type. For example, the UE 22 expects that no NTN-cell will be available the next 10 seconds, and during this period of time the UE 22 postpones cell reselection to TN-cells. However, if after 10 seconds (or after 10 seconds plus a margin time, e.g., an additional 1 second) there is still not any NTN cell available (which may happen for example due to temporary problems in NTN access or due to UE movements), the UE 22 may perform cell reselection to TN-cells.

In some embodiments, a specific time threshold may be provided via broadcast in System Information or dedicated RRC signaling. If the estimated coverage gap, i.e., time without serving of the first type of cell(s), is larger than a threshold, then UE 22 reselects to a cell of the second type. In some other embodiments, the choice may be a cell specific choice or a UE specific choice. If the choice is cell specific, it could be derived from SI. If the choice is UE specific, then the cell selection/reselection may be derived from an RRC message. If cell specific, there may be conditions to which UEs 22 this process applies e.g., based on UE capabilities, traffic type etc. In an alternative embodiment, a UE 22 may be assigned to prioritize being connected while other UEs 22 may be assigned to prioritize not making a tracking area update (TAU) and wait for NTN cell to reappear.

### Cell Service Type and Cell Reservations

In some embodiments, one or more levels of services (e.g., NR/LTE level of services) of a cell for a UE 22 comprise limited service, normal service, and operator service. A UE 22 may postpone its cell (re-)selection to the second type of cells (and thus also postpones the tracking area update) when there are not any cell(s) of the first type are available and cell(s) of the second type can only offer limited service. For example, a cell of a second type may be temporarily barred due to high peak load. However, a UE 22 may abort the postponement and continue with cell reselection procedure whenever the cell service type of a cell of second type changes to normal service.

### Change of UE Location

Another scenario where the UE 22 may abort the postponement and continue with its cell (re-)selection to the second type of cells is if the UE 22 determines that the UE 22 has moved (i.e., changed location). In some embodiments, the UE 22 may only determine it has moved when the absolute movement distance is above a certain distance which can measured with the equipped GNSS receiver. The distance may be measured from the location where the UE 22 was when the first cell became unavailable or from the NTN cell reference location. Other means to determine movement include but are not limited to the use of gyroscopes, barometric pressure sensors, or accelerometers. The UE 22 may also take into account the information in the footprintInfo-r17 information element (IE) in SIB32, when determining if its movement motivates aborting the postponement behavior.

Communicating with the Network (e.g., NN 16)

In some embodiments, it is left to the UE 22 to decide whether to skip/postpone the cell reselection to the second type of cell(s) and the subsequent tracking area update that may be a consequence of such a cell reselection, and instead wait for the coverage of the first type of cell(s) to return. The UE 22 may base this decisions on: the delay tolerance of the application(s) that may be installed/implemented and/or running on the UE 22; whether there is any uplink data pending to be sent from the ULE 22; whether the UE 22 is aware of any uplink data expected to be transmitted from the UE 22 or any downlink data that is expected to be transmitted to the UE 22 (which the UE 22 may predict if it has a regular, e.g. periodic, communication pattern) during the gap in the coverage of the first type of cell(s). For example, if the UE 22, based on such considerations, determines that its performance (and/or its applications performance) and/or quality of service and/or quality of experience may be significantly reduced by waiting for the coverage of the first type of cell(s) to return, the UE 22 may decide not to wait for the coverage of the first type of cell(s) to return and instead perform the cell reselection to a cell of the second type and perform the subsequent tracking area update.

In some other embodiments, in case a procedure in the UE 22 is initiated which requires the UE 22 to communicate with the network (e.g., the UE 22 needs to communicate with the core network, or the UE 22 needs to send or potentially receive some data), the UE 22 may stop the postponement procedure and directly reselect to the second type of cell and/or connect to the second type of cell.

In some embodiments, in all of the above considerations of whether to reselect to a cell of the second type, the UE 22 may consider different data to be of different importance, for example an emergency service is more important than some browsing data. In some other embodiments, the UE 22 may abort the postponement procedure for a first type of data (e.g., emergency) but not for a second type of data (e.g., browsing). Letting arrival of certain types of data in the UE uplink transmission buffer(s) trigger aborting of the postponement may be used both in embodiments where the UE 22 autonomously controls its postponement behavior and in embodiments where the UE postponement behavior is (at least partly) configured by the network.

### Operating Critical or Higher Priority Channels or Signals

In one example, the ULE 22 may be preconfigured with resources or a configured grant (CG) which are reserved for transmitting physical uplink shared channel (PUSCH) while in RRC IDLE/RRC_INACTIVE state. Transmissions using preconfigured resources or configured grant may also be referred as preconfigured UL resource (PUR) or configured grant small data transmission (CG-SDT). The preconfigured resources allow UE 22 to transmit in uplink using PUSCH with certain periodicity and at specific set of preconfigured resources. In one example, the UE 22 aborts the postponement of cell change when a transmission using preconfigured resources are triggered in the UE 22 while in discontinuous coverage. One reason for aborting the postponement may be that if the UE 22 misses the intendent transmission which occurs or is expected to occur during the discontinuous coverage, the UE 22 may have to wait until the next PUR occasion which may happen after some time. In some embodiments, the transmissions using configured grant or preconfigured resources can be considered as critical.

In a second example, the UE 22 can be configured or requested to perform critical measurements which may require the UE 22 to measure in DL and/or transmit in UL for positioning measurements. Examples of the positioning measurements are observed time difference of arrival (OTDOA), reference signal time difference (RSTD), UE-Rx time difference measurement, etc. The UE 22 may abort the postponement of the cell change, i.e., the UE 22 may perform the cell change to cell2 and perform measurements (e.g., critical measurements) provided that cell2 has met the cell change criteria regardless of one or more rules.

### Signal Situation Changes

During the time when the UE 22 is in coverage of the first and second type of cells, the UE 22 is expected to camp on the best of the first and second type of cells, e.g., unless the UE 22 has been configured to prioritize one of them. A UE 22 may postpone cell (re-)selection considering signal strength/quality (e.g., RSRP/RSRQ). In one embodiment, the UE 22 may abort the postponement behavior if the second cell (or cell of the second type) becomes stronger or of higher quality than the first cell (or cells of the first type).

In some embodiments, when the first cell (or cells of the first type) is not available (e.g., satellite coverage has temporarily become unavailable), the UE 22 may have no means to compare the first and the second type of cells. In some other embodiments, the UE 22 may consider the quality/strength of the (currently unavailable) NTN network to have the last known quality/strength. For example, if the UE 22 was served by NTN-cell A, but when the coverage of NTN-cell A disappears the UE 22 may not have coverage from any NTN-cell. According to this embodiment, the UE 22 may consider the signal quality/strength of (currently unavailable) NTN-cells to be the last known/measured quality/strength of NTN-cell A.

The following is a nonlimiting list of example embodiments.

Embodiment A1. A user equipment (UE) configured to communicate with a first network node (NN) and/or a second NN, the first NN being associated with a first cell, the second NN being associated with a second cell, the UE being configured to, and/or comprising a radio interface and/or processing circuitry configured to:
determine a postponement of a cell selection action when the cell selection action is selecting the second cell for communication with the UE, the postponement being determined based on predetermined criteria associated with one or both of the UE and the second NN; and

Embodiment A2. The UE of Embodiment A1, wherein the UE is configured to one or more of:
determine the first cell has become unavailable to communicate with the first NN;
determine the cell selection action is to select the second cell associated with the second NN based on the determination that the first cell has become unavailable;
postpone the cell selection action based on the determined postponement; and
one or both of receive and transmit signaling based on the postponement.

Embodiment A3. The UE of any one of Embodiments A1 and A2, wherein the predetermined criteria comprise one or more of:
a mobility parameter,
a cell service parameter;
a cell reservation parameter;
duration of a coverage gap associated with the first cell;
a traffic pattern; and
a signal parameter.

Embodiment A4. The UE of any one of Embodiments A1-A3, wherein one or more of:
the first NN is associated with a non-terrestrial network (NTN);
the second NN is associated with a terrestrial network (TN);
the first NN is a satellite; and
the second NN is a TN NN.

Embodiment B1. A method in a user equipment (UE) configured to communicate with a first network node (NN) and/or a second NN, the first NN being associated with a first cell, the second NN being associated with a second cell, the method comprising:
determining a postponement of a cell selection action when the cell selection action is selecting the second cell for communication with the UE, the postponement being determined based on predetermined criteria associated with one or both of the UE and the second NN.

Embodiment B2. The method of Embodiment B1, wherein the method further comprises one or more of:
determining the first cell has become unavailable to communicate with the first NN;
determining the cell selection action is to select the second cell associated with the second NN based on the determination that the first cell has become unavailable;
postponing the cell selection action based on the determined postponement; and
one or both of receiving and transmitting signaling based on the postponement.

Embodiment B3. The method of any one of Embodiments B1 and B2, wherein the predetermined criteria comprise one or more of:
a mobility parameter,
a cell service parameter;
a cell reservation parameter;
duration of a coverage gap associated with the first cell;
a traffic pattern; and
a signal parameter.

Embodiment B4. The method of any one of Embodiments B1-B3, wherein one or more of:
the first NN is associated with a non-terrestrial network (NTN);
the second NN is associated with a terrestrial network (TN);
the first NN is a satellite; and
the second NN is a TN NN.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G 5th Generation
BS Base Station
CG-SDT Configured Grant—Small Data Transmission
CHO Conditional Handover
eNB Evolved NodeB (LTE base station)
GEO Geostationary Orbit
gNB Base station in NR.
GNSS Global Navigation Satellite System
HO Handover
LEO Low Earth Orbit
LTE Long Term Evolution
MAC Medium Access Control
NGSO Non Geosynchronous Orbit
NR New Radio
NW Network
NTN Non-Terrestrial Network
OTDOA Observed Time Difference Of Arrival
PUR Preconfigured Uplink Resources
RAT Radio Access Technology
RRC Radio Resource Control
RRM Radio Resource Management
RS Reference Signal
RSRP Reference Signal Received Power
RSTD Reference signal time difference
SMTC SSB Measurement Timing Configuration
SNR Signal to noise ratio
UE User Equipment

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a user equipment, UE, configured to communicate with a first network node, NN, and a second NN, the first NN being associated with a first cell, the second NN being associated with a second cell, the method comprising:
determining a postponement of a cell selection action, the cell selection action including selecting the second cell for communication with the UE, the postponement being determined based on predetermined criteria associated with one or both of the UE and the second NN; and
aborting the postponement of a cell selection action based on one or more conditions, the one or more conditions including one or more of:
the first cell not becoming available to the UE after a predetermined time;
a cell service type of the second cell changes to normal service;
a location of the UE has changed;
quality of experience below a quality of experience threshold if postponement is performed;
the UE being initiated;
a type of signal associated with the UE, the type of signal being critical;
a type of communication channel associated with the UE, the type of communication channel being critical;
the UE being preconfigured with one or more predetermined resources;
the UE having to perform one or more measurements;
a signal strength below a signal strength threshold; and
a signal quality below a signal quality threshold.

2. The method of claim 1, wherein the method further includes one or more of:
determining the first cell has become unavailable to communicate with the first NN;
determining that the cell selection action includes selecting the second cell associated with the second NN based on the determination that the first cell has become unavailable; and
one or both of receiving and transmitting signaling based on the postponement.

3. The method of claim 1, wherein the predetermined criteria comprise one or more of:
a mobility parameter;
a cell service parameter;
a cell reservation parameter;
duration of a coverage gap associated with the first cell;
a traffic pattern; and
a signal parameter.

4. The method of claim 1, wherein the method further includes:
determining a duration of one or more coverage gaps associated with one or both of the first cell and the first NN based on a system information block; and
when the one or more coverage gap start, stopping one or more functions related to one or both of the first cell and the first NN and reselecting one of the first cell and second cell based on the predetermined criteria.

5. The method of claim 1, wherein the method further includes:
when the UE moves from the first cell to the second cell based on the cell selection action and the second cell is associated with another tracking area, performing a tracking area update process during which the UE indicates at least to the second NN the other tracking area the UE has camped in.

6. The method of claim 1, wherein the method further includes:
receiving an indication from one or both of the first NN and the second NN, the indication indicating the UE to perform the postponement or to not perform the postponement, the indication being based on one or more of a UE capability, historical traffic patterns of the UE, an expected next communication event, and data flow.

7. The method of claim 1, wherein the postponement is autonomously determined by the UE further based on a predetermined threshold for an expected duration of a coverage gap in the first cell.

8. The method of claim 1, wherein the postponement is autonomously determined by the UE further based on one or both of a battery status and an energy status associated with the UE.

9. The method of claim 1, wherein the postponement is autonomously determined by the UE further based on whether there is one or both of uplink data and downlink data pending to be transmitted during an expected duration of a coverage gap in the first cell.

10. (canceled)

11. (canceled)

12. The method of claim 1, wherein one or more of:
the first NN is associated with a non-terrestrial network, NTN;
the second NN is associated with a terrestrial network, TN;
the first NN is a satellite; and
the second NN is a TN NN.

13. A user equipment, UE, configured to communicate with a first network node, NN, and a second NN, the first NN being associated with a first cell, the second NN being associated with a second cell, the UE-2 being configured to:
determine a postponement of a cell selection action, the cell selection action including selecting the second cell for communication with the UE, the postponement being determined based on predetermined criteria associated with one or both of the UE and the second NN; and
abort the postponement of a cell selection action based on one or more conditions, the one or more conditions including one or more of:
the first cell not becoming available to the UE after a predetermined time;
a cell service type of the second cell changes to normal service;
a location of the UE has changed;
quality of experience below a quality of experience threshold if postponement is performed;
the UE being initiated;
a type of signal associated with the UE, the type of signal being critical;
a type of communication channel associated with the UE, the type of communication channel being critical;
the UE being preconfigured with one or more predetermined resources;
the UE having to perform one or more measurements;
a signal strength below a signal strength threshold; and
a signal quality below a signal quality threshold.

14.-24. (canceled)

25. A method in a second network node, NN, configured to communicate with a user equipment, UE, the UE being configured to communicate with a first network node, NN, the first NN being associated with a first cell, the second NN being associated with a second cell, the method comprising:
determining a first indication indicating a postponement of a cell selection action, the cell selection action including selecting the second cell for communication with the UE, the postponement being based on predetermined criteria associated with one or both of the UE and the second NN;
transmitting the first indication to the UE based on the determination; and
the first indication causing the UE to abort the postponement of a cell selection action based on one or more conditions, the one or more conditions including one or more of:
the first cell not becoming available to the UE after a predetermined time;
a cell service type of the second cell changes to normal service;
a location of the UE has changed;
quality of experience below a quality of experience threshold if postponement is performed;
the UE being initiated;
a type of signal associated with the UE, the type of signal being critical;
a type of communication channel associated with the UE, the type of communication channel being critical;
the UE being preconfigured with one or more predetermined resources;
the UE having to perform one or more measurements;
a signal strength below a signal strength threshold; and
a signal quality below a signal quality threshold.

26. The method of claim 25, wherein the predetermined criteria comprise one or more of:
a mobility parameter;
a cell service parameter;
a cell reservation parameter;
duration of a coverage gap associated with the first cell;
a traffic pattern; and
a signal parameter.

27. (canceled)

28. (canceled)

29. The method of claim 25, wherein the first indication is further determined being based on one or more of a UE capability, historical traffic patterns of the UE, an expected next communication event, and data flow.

30. (canceled)

31. (canceled)

32. The method of claim 25, wherein one or more of:
the first NN is associated with a non-terrestrial network, NTN;
the second NN is associated with a terrestrial network, TN;
the first NN is a satellite; and
the second NN is a TN NN.

33. A second network node, NN, configured to communicate with a user equipment, UE, the UE being configured to communicate with a first network node, NN, the first NN being associated with a first cell, the second NN being associated with a second cell, the second NN being configured to:
determine a first indication indicating a postponement of a cell selection action, the cell selection action including selecting the second cell for communication with the UE, the postponement being based on predetermined criteria associated with one or both of the UE and the second NN;
transmit the first indication to the UE based on the determination; and
the first indication causing the UE to abort the postponement of a cell selection action based on one or more conditions, the one or more conditions including one or more of:
the first cell not becoming available to the UE after a predetermined time;
a cell service type of the second cell changes to normal service;
a location of the UE has changed;
quality of experience below a quality of experience threshold if postponement is performed;
the UE being initiated;
a type of signal associated with the UE, the type of signal being critical;
a type of communication channel associated with the UE, the type of communication channel being critical;
the UE being preconfigured with one or more predetermined resources;
the UE having to perform one or more measurements;
a signal strength below a signal strength threshold; and
a signal quality below a signal quality threshold.

34.-40. (canceled)
